(19) United States
(12) Patent Application Publication
(10) Pub. No.: US 2014/0306021 A1
(43) Pub. Date: Oct. 16, 2014

(54) AIR CONDITIONING CONTROL DEVICE, AIR CONDITIONING SYSTEM, AND AIR CONDITIONING CONTROL METHOD THEREOF

(71) Applicant: GEMTEK TECHNOLOGY CO., LTD., Hsinchu (TW)

(72) Inventors: CORY KOON-SING LAM, Hsinchu (TW); CHANG-YUAN HSIEH, Hsinchu (TW); HUNG-YANG LEE, Hsinchu (TW); CHANG-HUNG CHEN, Hsinchu (TW); WEI-LI HSU, Hsinchu (TW); SHENG-YUAN WANG, Hsinchu (TW)

(21) Appl. No.: 13/917,838

(22) Filed: Jun. 14, 2013

(30) Foreign Application Priority Data
Apr. 12, 2013 (TW) 102113035

(51) Int. Cl. G05D 23/19

(52) U.S. Cl. CPC G05D 23/19
USPC 236/51

(57) ABSTRACT

The present invention discloses an air conditioner control device, air conditioning system, and air conditioner control method. The air conditioner control device of the present invention comprises a base and a controller. The base senses a temperature or humidity of a first environment. The controller can be optionally combined with or detached from the base. When the controller is detached from the base, the controller senses a temperature or humidity of a second environment and communicates with the base using a wireless network protocol. By doing so, the output of an air conditioner can be flexibly adjusted depending on the environment that a user is in.

### CROSS-REFERENCE TO RELATED APPLICATIONS

This non-provisional application claims priorities under 35 U.S.C. § 119(a) on Patent Application No. 102113035 filed in Taiwan R.O.C. on Apr. 12, 2013, the entire contents of which are hereby incorporated by reference.

### BACKGROUND OF THE INVENTION

1. Field of the Invention

The present invention relates to an air conditioning control device, air conditioning system, and air conditioning control method. More particularly, the present invention relates to an air conditioning control device comprising a base and a controller which can be optionally combined with or detached from the base, and relates to an air conditioning system and air conditioning control method using such a control device.

2. Description of the Prior Art

A thermostat is a device used for controlling the air conditioning temperature of an HVAC (Heating, Ventilation and Air Conditioning) system, so that the system's temperature can be maintained near a desired set point. The user may adjust the temperature settings on a thermostat, which will further manage and control the input and output thermal energy of the HVAC system. In other words, a thermostat switches a heating or air conditioning system on or off to maintain a desired temperature.

FIG. 1 is a schematic diagram illustrating a user operating a conventional thermostat. As shown in FIG. 1, a conventional thermostat 1 is usually designed to be hung at a fixed position on the wall, and the user needs to approach that fixed position to operate the thermostat 1; however, this may cause inconvenience to the user. Besides, the design of a conventional thermostat 1 has other drawbacks. For example, when the user uses the conventional thermostat 1 to control the air conditioning of the environment he is in, it is often that the temperature and humidity of a whole larger area are adjusted, while the whole area may contain several or dozens of compartments. This will cause other people in the same large area exposed to the same room temperature. However, the same temperature may create different feelings of comfort for different individuals; for example, some may find it cool enough while others may not. And in terms of energy saving, this aspect of a conventional thermostat may result in unnecessary waste of energy.

In view of the above, a need exists in the market for designing an ideal air conditioning control device, air conditioning system and air conditioning control method that will allow the user to operate in a more convenient way, provide the user with a more comfortable environment, and reduce the waste of energy.

### SUMMARY OF THE INVENTION

To improve the drawbacks of a conventional air conditioning control device as described above, an object of the present invention is to provide an air conditioning control device, air conditioning system, and air conditioning control method addressing the above problems related to user convenience, user comfort and energy saving.

According to the object of the present invention, an air conditioner control device is provided, comprising a base and a controller. The base senses a temperature or humidity of a first environment. The controller can be optionally combined with or detached from the base. When the controller is detached from the base, the controller senses a temperature or humidity of a second environment and communicates with the base using a wireless network protocol.

According to the object of the present invention, an air conditioner control method is further provided, comprising: arranging a base in a first environment to sense a temperature or humidity thereof; providing a controller which can be optionally combined with or detached from the base; enabling the controller to sense a temperature or humidity of a second environment when the controller is detached from the base; and enabling the controller to communicate with the base using a wireless network protocol.

According to the object of the present invention, an air conditioning system is still further provided, comprising an air conditioner and the air conditioner control device as described above, wherein the air conditioner control device controls output of the air conditioner.

The aforementioned aspects and other aspects of the present invention will be better understood with reference to the following exemplary embodiments and drawings.

### BRIEF DESCRIPTION OF THE DRAWINGS

FIG. 1 is a schematic diagram illustrating a user operating a conventional thermostat.

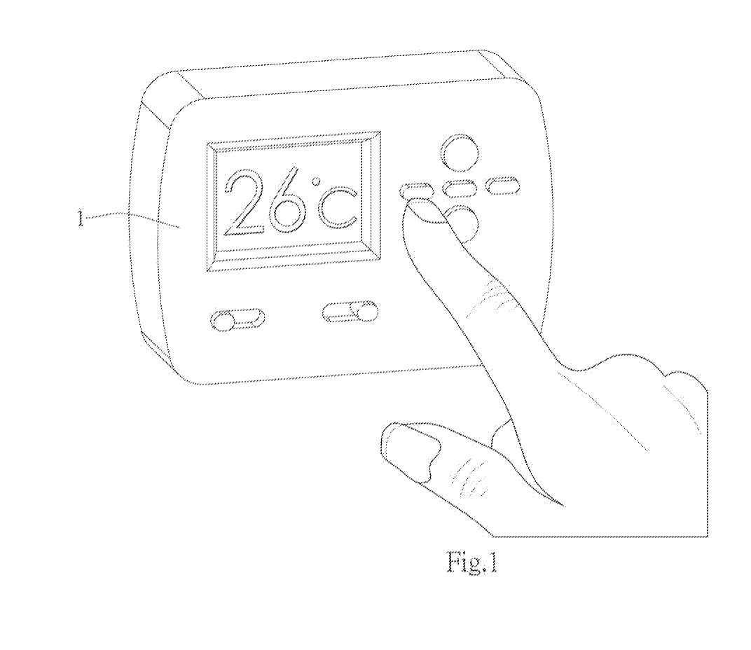

FIG. 2A is a schematic diagram showing a combined structure of an air conditioner control device according to a first embodiment of the present invention.

FIG. 2B is a block diagram representing the combined structure shown in FIG. 2A.

FIG. 3A is a schematic diagram showing a split structure of an air conditioner control device according to a second embodiment of the present invention.

FIG. 3B is a block diagram representing the split structure shown in FIG. 3A.

FIG. 4 is a block diagram representing the network communication of an air conditioner control device according to one embodiment of the present invention.

FIG. 5 is a schematic diagram showing a connection unit of an air conditioner control device according to one embodiment of the present invention.

FIG. 6 is a schematic diagram showing a connection unit of an air conditioner control device according to an alternative embodiment of the present invention.

FIG. 7 is a flow chart showing an air conditioner control method according to one embodiment of the present invention.

### DETAILED DESCRIPTION OF THE PREFERRED EMBODIMENTS

The present invention will be fully described by way of preferred embodiments and appended drawings to facilitate the understanding of the technical features, contents and advantages of the present invention. It will be understood that the appended drawings are merely schematic representations and may not be illustrated according to actual scale and precise arrangement of the implemented invention. Therefore, the present invention shall not be construed based on the scale and arrangement illustrated on the appended drawings, and the embodiments and appended drawings are not intended to limit the scope of protection of the present invention.

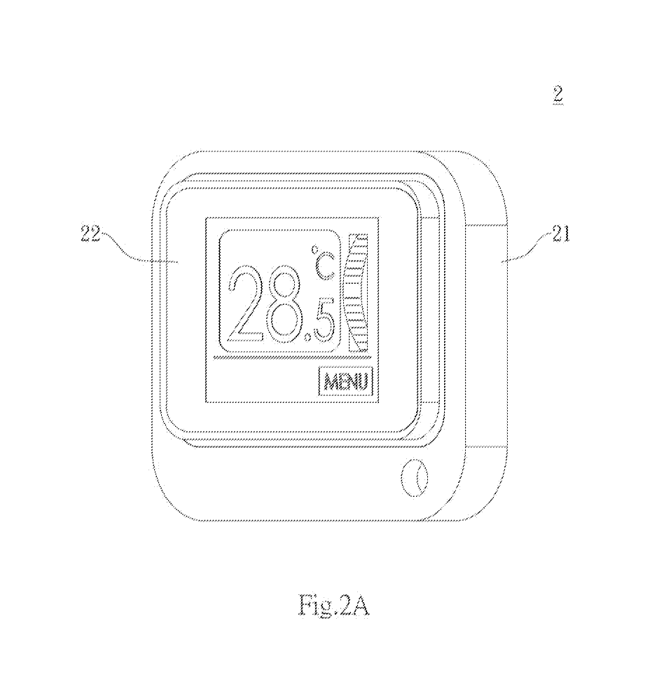

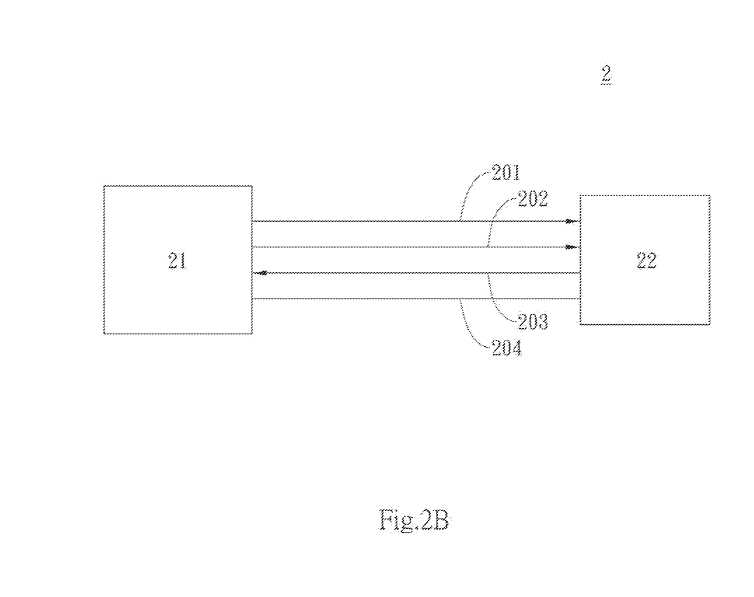

Please refer to FIGS. 2A and 2B. FIG. 2A is a schematic diagram showing a combined structure of an air conditioner control device according to a first embodiment of the present invention. FIG. 2B is a block diagram representing the combined structure shown in FIG. 2A to illustrate a basic implementation and structure of an air conditioner control device in accordance with the present invention. As shown in FIGS. 2A and 2B, an air conditioner control device 2 of the present invention mainly comprises a base 21 and a controller 22. In an embodiment of the present invention, the base 21 may preferably be mounted on a fixed position on the wall. The base 21 can sense the ambient temperature or humidity in an environment.

In an embodiment of the present invention as shown in FIG. 2A, the base 21 may be combined with the controller 22 to form the air conditioner control device 2. After the base 21 senses the ambient temperature or humidity, the user may use the controller 22 on the base 21 to adjust the ambient temperature or humidity settings based on the sensed results. When the base 21 is combined with the controller 22, a preferable implementation of wired communication between them is illustrated in FIG. 2B. In this embodiment, the wired communication between the base 21 and the controller 22 is preferably implemented by a power wire 201, transmission wire 202, reception wire 203, and ground wire 204, but the implementation is not limited to the means described herein. In brief, based on the communication between the base 21 and the controller 22, the user may use the air conditioner control device 2 to control the output of an air conditioner (not shown) installed in the environment he or she is in.

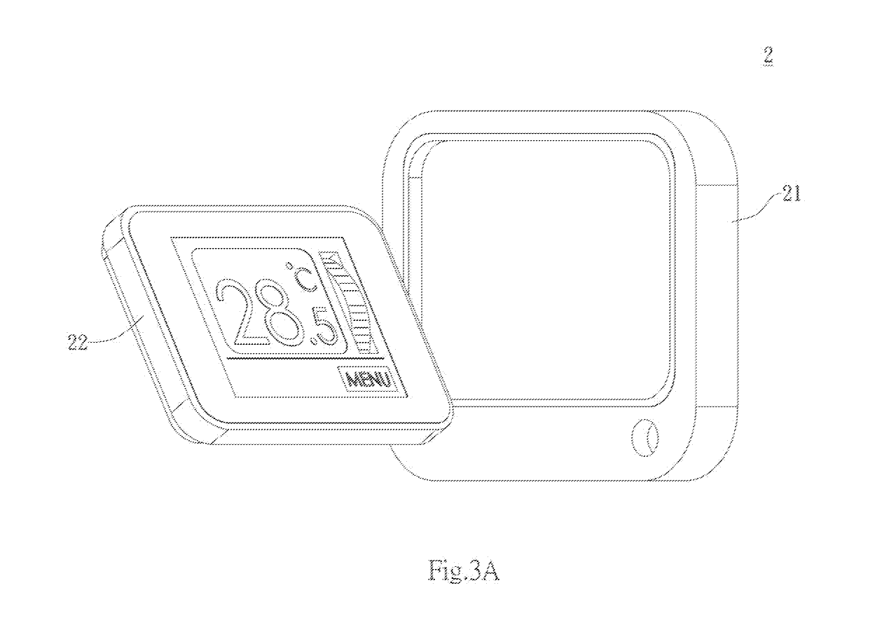

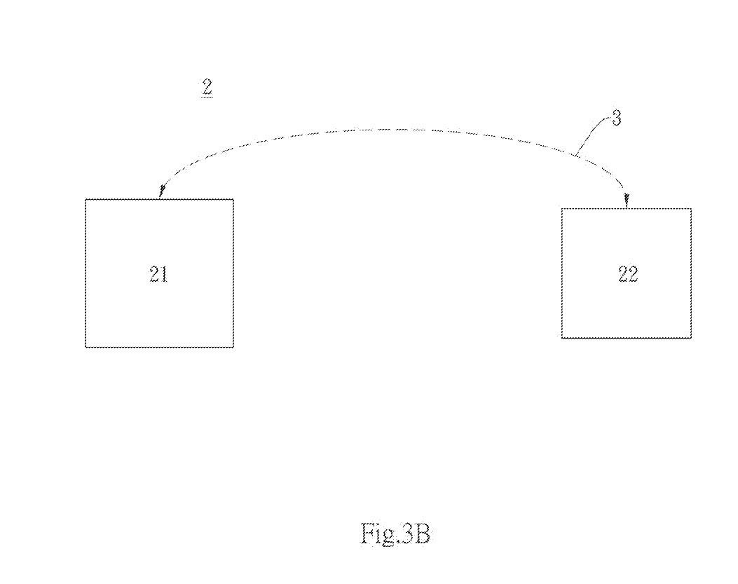

Please refer to FIGS. 3A and 3B. FIG. 3A is a schematic diagram showing a split structure of an air conditioner control device according to a second embodiment of the present invention. FIG. 3B is a block diagram representing the split structure shown in FIG. 3A to illustrate an alternative implementation and structure of an air conditioner control device in accordance with the present invention. In the second embodiment of the present invention, the implementation of the base 21 is substantially the same as that in the first embodiment. That is, the base 21 may preferably be mounted on a fixed position on the wall, and the base 21 can sense the ambient temperature or humidity in an environment (such as a first environment).

However, this embodiment is different from the first embodiment in that the controller 22 is preferably detached from the base 21 of the air conditioner control device 2, as shown in FIG. 3A. This means that the base 21 can sense the temperature or humidity of a first environment, while the controller 22, which is detached from the base 21, can sense the temperature or humidity of a second environment. As the base 21 and the controller 22 are separate from each other, the communication between them may be achieved by using a wireless network 3 (as shown in FIG. 3B). For example, since the base 21 is placed at a fixed position, it will sense the ambient temperature or humidity of the environment (i.e., the first environment) it is in. Moreover, the user may use the controller 22, which is detached from the base 21, to sense the ambient temperature or humidity of a different environment (i.e., the second environment) that the user is in. Then the user may use the controller 22, which communicates with the base 21 via a wireless network 3, to further adjust the desired temperature or humidity of the second environment. In this embodiment, the network protocol used by the wireless network 3 is preferably ZigBee, Z-Wave or other low energy Bluetooth protocols, but is not limited to these wireless communication protocols and means.

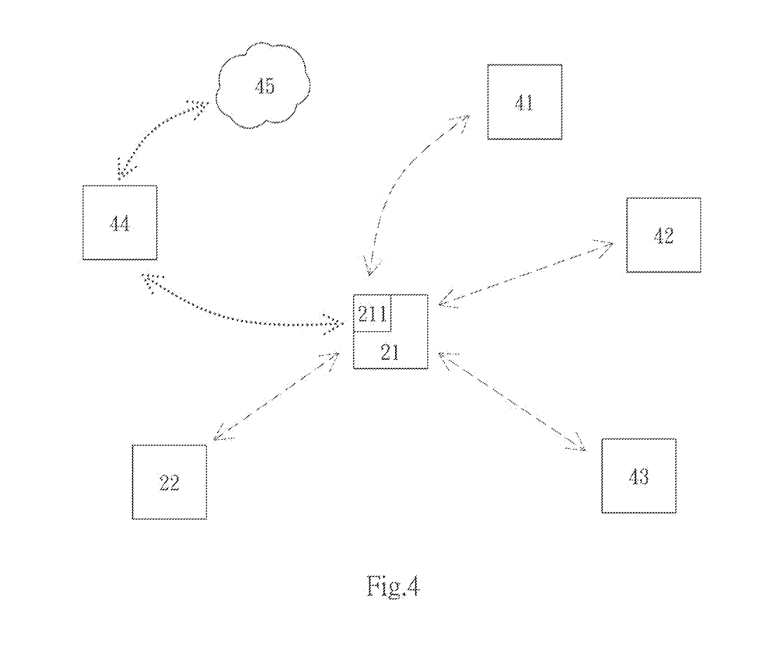

FIG. 4 is a block diagram representing the network communication of an air conditioner control device according to one embodiment of the present invention; the figure illustrates a further implementation method using the air conditioner control device. As shown in FIG. 4, the implementation with respect to the base 21 and the controller 22 is substantially the same as that in the first and second embodiments.

However, it should be noted that in this embodiment, the controller 22 may communicate with at least one electrical device within an area through the base 21 based on a wireless network protocol (such as the above-mentioned ZigBee protocol). That is to say, whether the base 21 and the controller 22 are combined with or detached from one another, the user may use the controller 22, which communicates with other electrical devices through the base 21, to control and/or make adjustment to at least one electrical device within a certain area (e.g., a home area) which incorporates the same wireless network protocol. Examples of the electrical devices include a light adjusting device 41 in a study, a gas control device 42 in a kitchen, an intercom 43 in a hallway, etc. As long as these electrical devices incorporate the same wireless network protocol as the base 21 and the controller 22 of the air conditioner control device 2 do, the user may use the controller 22 to control and/or make adjustment to one or more electrical devices within a certain area through the base 21.

Moreover, it is preferable that in this embodiment, the base 21 comprises a wireless networking module 211 (e.g., a Wi-Fi module). Thus, based on the wireless networking module 211, the base 21 may further communicate with the “cloud” of the Internet 45 via a wireless router 45 and become a part of the Internet 45. For example, through the wireless networking module 211 of the base 21, the user may update the firmware of the air conditioner control device 2; or alternatively, the base 21 may be used to transmit data to the “cloud” of the Internet 45 in accordance with predetermined settings or the user's needs.

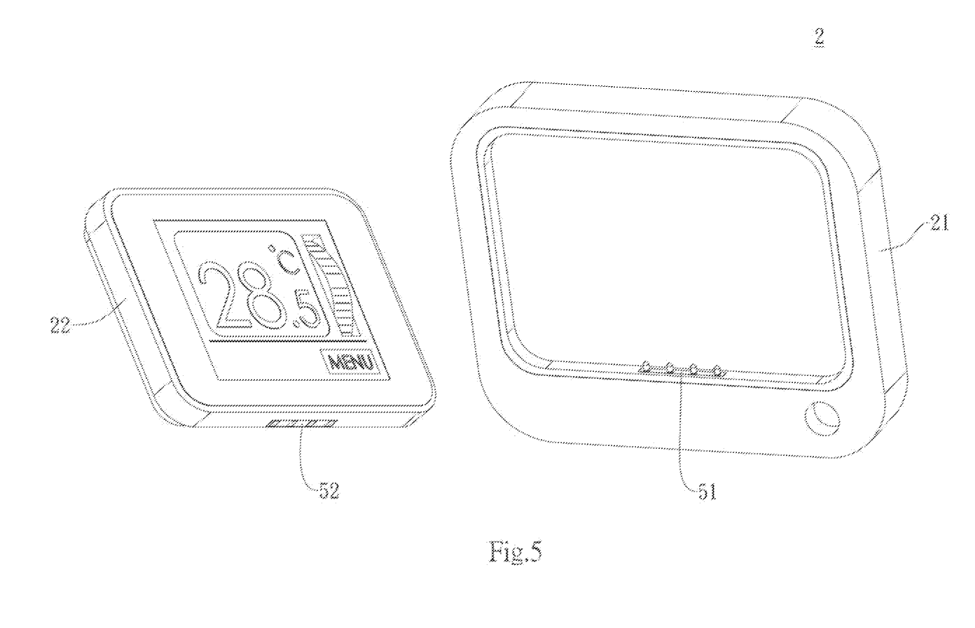

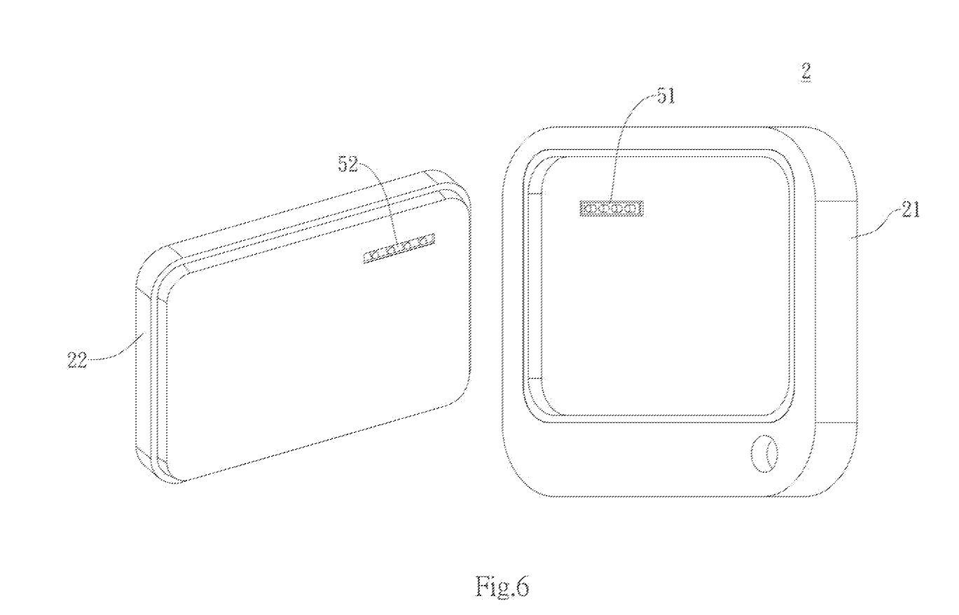

Please refer to FIGS. 5 and 6. FIG. 5 is a schematic diagram showing a connection unit of an air conditioner control device according to one embodiment of the present invention, and FIG. 6 is a schematic diagram showing a connection unit of an air conditioner control device according to an alternative embodiment of the present invention. Both FIG. 5 and FIG. 6 illustrate the connection means used in an air conditioner control device of the present invention. As shown in FIGS. 5 and 6, in these two embodiments, the connection between the base 21 and the controller is preferably implemented by a pin connection unit (e.g., a pogo pin connector). For example, the pin connection unit may comprise a first connecting portion 52 arranged at the bottom of the controller 22 and a second connecting portion 51 arranged at a corresponding position at the base 21 (as shown in FIG. 5), opposite the first connecting portion 52. Alternatively, the pin connection unit may comprise a first connecting portion 52 arranged at the back side of the controller 22 and a second connecting portion 51 arranged at a corresponding position at the base 21 (as shown in FIG. 6), opposite the first connecting portion 52. However, the pin connection unit is not limited to the aforementioned two arrangements in real practice. The base 21 and the controller 22 can be connected easily and stably by using the pin connection unit, but in real practice, the connection means in an air conditioner control device of the present invention is not limited to the one described.

A person having ordinarily knowledge in the art will understand that the aforementioned embodiments regarding wired transmission techniques, wireless network protocols (e.g., ZigBee, etc.), use of the Internet, arrangement of the pin connection unit, connection means, etc., are exemplary and are not intended to limit the present invention. Any device made without departing from the spirit and scope of the air conditioner control device of the present invention falls within the scope of the present invention.

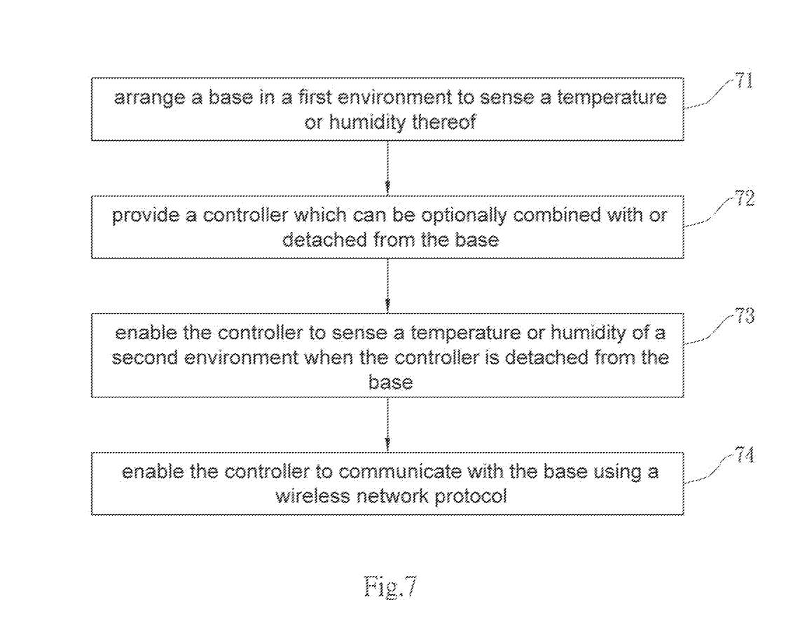

FIG. 7 is a flow chart showing an air conditioner control method according to one embodiment of the present invention. As shown in FIG. 7, the air conditioner control method of the present invention comprises the following steps. In step 71, arrange a base in a first environment to sense a temperature or humidity thereof. In step 72, provide a controller which can be optionally combined with or detached from the base. In step 73, enable the controller to sense a temperature or humidity of a second environment when the controller is detached from the base. In step 74, enable the controller to communicate with the base using a wireless network protocol.

To avoid repetition, the details and embodiments of the air conditioner control method of the present invention can be referred to the above descriptions, where various embodiments of the air conditioner control device of the present invention are described.

To sum up, the present invention provides an air conditioner control device, air conditioning system, and air conditioner control method having the following advantages: the user is allowed to operate an air conditioner control device more freely and more conveniently, and the user's feeling of comfort in an air conditioning environment is also increased. Moreover, the air conditioner control device of the present invention allows the user to flexibly adjust the desired temperature or humidity depending on the compartment or the section of a larger area that the user is actually in, and thus, unnecessary waste of energy can be reduced.

The air conditioner control device, air conditioning system, and air conditioner control method of the present invention have been fully described with preferred embodiments and the appended drawings. All of the advantageous features disclosed in this specification may be combined in any combination. Each feature disclosed in this specification may be replaced by an alternative feature serving the same, equivalent, or similar purpose. Thus, except for those particularly distinctive features, each feature disclosed is only an example of a generic series of equivalent or similar features. Given the above description of preferred embodiments, those skilled in the art would understand that the present invention features several aspects of novelty and inventive step over the prior art and is industrially applicable. Various modifications and substitutions may be made by those skilled in the art without departing from the spirit and scope of the present invention.

What is claimed is:

1. An air conditioner control device, comprising:
a base for sensing a temperature or humidity of a first environment; and
a controller, which can be optionally combined with or detached from the base;
wherein when the controller is detached from the base, the controller senses a temperature or humidity of a second environment and communicates with the base using a wireless network protocol.

2. The air conditioner control device according to claim 1, wherein the controller communicates with the base using a wired transmission technique when the controller is combined with the base.

3. The air conditioner control device according to claim 1, wherein the controller communicates with at least one electrical device within an area through the base based on the wireless network protocol.

4. The air conditioner control device according to claim 1, wherein the base incorporates Wi-Fi technology.

5. The air conditioner control device according to claim 1, wherein the controller and the base are combined with each other by a pin connection unit.

6. An air conditioning system, comprising an air conditioner and an air conditioner control device according to claim 1, wherein the air conditioner control device controls output of the air conditioner.

7. An air conditioning system, comprising an air conditioner and an air conditioner control device according to claim 2, wherein the air conditioner control device controls output of the air conditioner.

8. An air conditioning system, comprising an air conditioner and an air conditioner control device according to claim 3, wherein the air conditioner control device controls output of the air conditioner.

9. An air conditioning system, comprising an air conditioner and an air conditioner control device according to claim 4, wherein the air conditioner control device controls output of the air conditioner.

10. An air conditioning system, comprising an air conditioner and an air conditioner control device according to claim 5, wherein the air conditioner control device controls output of the air conditioner.

11. An air conditioner control method, comprising:
arranging a base in a first environment to sense a temperature or humidity thereof;
providing a controller which can be optionally combined with or detached from the base;
enabling the controller to sense a temperature or humidity of a second environment when the controller is detached from the base; and
enabling the controller to communicate with the base using a wireless network protocol.

12. The air conditioner control method according to claim 11, further comprising:
enabling the controller to communicate with the base via a wired transmission technique when the controller is combined with the base.

13. The air conditioner control method according to claim 11, further comprising:
enabling the controller to communicate with at least one electrical device within an area through the base based on the wireless network protocol.

14. The air conditioner control method according to claim 11, wherein the base incorporates Wi-Fi technology.

15. The air conditioner control method according to claim 11, further comprising:
enabling the controller and the base to be combined with each other by a pin connection unit.
